(19) United States
(12) Patent Application Publication
(10) Pub. No.: US 2007/0297421 A1
(43) Pub. Date: Dec. 27, 2007

(54) Communications network

(75) Inventor: Steve D. Huseth, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/475,311

(22) Filed: Jun. 27, 2006

(51) Int. Cl. H04L 12/56

(52) U.S. Cl. 370/400

(57) ABSTRACT

In an embodiment, a temporary network is implemented by locating a plurality of battery-powered Wi-Fi access points throughout a local area. A controller is also located within the local area. A network connectable device is provided to communicate with the plurality of battery-powered Wi-Fi access points and the controller. The temporary network may then be implemented via the automatic configuration of the plurality of Wi-Fi access points and the configuration of the controller via the network connectable device.

### FIELD OF THE INVENTION

Various embodiments relate to communications networks, and in an embodiment, but not by way of limitation, to temporary installation and configuration of communications networks.

### BACKGROUND

When a new building is commissioned or reconfigured, the installer must visit a large number of locations throughout the building. At each location, the installer must make local configuration changes to an executive controller located in a central control center in the building. This executive controller can be configured through the use of a computer network. However, there are many instances in which the installation of such a computer network is difficult, not worth the effort, or nearly impossible. In the case of commissioning a new building, the locations of access points may be in a section of the building to which power has not yet been supplied. Configuring an executive controller through Ethernet interfaces and local area networks then is just not possible. Moreover, because the access points and executive controller are not likely located in the same physical area, it is difficult for an installer to physically visit different areas of the building, and yet still have access to the central control center. One manner to overcome this problem is to position a second installer at the executive controller, and to instruct this second installer to make configuration changes using voice radios and/or cell phones. However, this is at times an unwieldy situation, may be hampered by poor cell phone transmission and reception within a structure, and requires the presence of at least two persons.

### BRIEF DESCRIPTION OF THE DRAWINGS

FIG. 1 illustrates an example embodiment of a process to install a temporary network in a localized area.

FIG. 2 illustrates another example embodiment of a process to install a temporary network in a localized area.

FIG. 3 illustrates a diagram of an example embodiment of a network in a localized area.

FIG. 4 illustrates an embodiment of a computer system upon which one or more embodiments of the present disclosure may operate.

### SUMMARY

In an embodiment, a temporary network is implemented by first locating a plurality of battery-powered Wi-Fi access points throughout a local area. A controller is also placed within the local area. A network connectable device is provided to communicate with the plurality of battery-powered Wi-Fi access points and the controller. A temporary network may then be implemented via an automatic configuration of the plurality of Wi-Fi access points in connection with the configuration of the controller via the network connectable device.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein.

A number of figures show block diagrams of systems and apparatus for temporarily installing a computer network in accordance with embodiments of the invention. A number of figures show flow diagrams illustrating systems and apparatus for such temporarily-installed networks. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

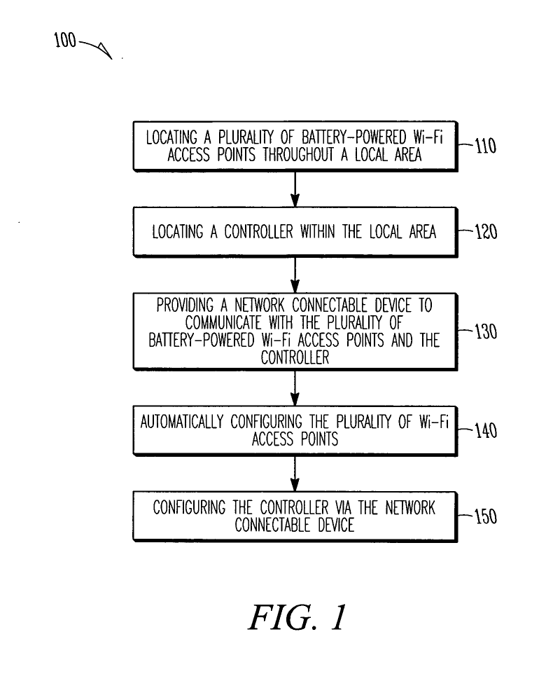

FIG. 1 illustrates an example embodiment of a process 100 for installing a temporary Wi-Fi network in a newly commissioned building. While the present disclosure discusses the installation of a Wi-Fi network in a newly commissioned building, the present disclosure may be applied to other locations and/or situations other than a newly commissioned building in which a temporarily installed network would be useful.

Referring specifically to FIG. 1, the process 100 includes locating a plurality of battery-powered Wi-Fi access points throughout a local area at operation 110. At operation 120, a controller is located within the local area. A network connectable device is provided at operation 130. The network connectable device allows communication with the plurality of battery-powered Wi-Fi access points and the controller. At operation 140, the plurality of Wi-Fi access points are automatically configured, and the controller is configured via the network connectable device at operation 150. When the configuration of the network is complete, the plurality of battery-powered Wi-Fi access points may be removed from the local area. In an embodiment, the Wi-Fi access points are automatically configured via the Domain Host Configuration Protocol (DHCP). In other embodiments, other automatic configuration protocols could be used.

In another embodiment, the process 100 of FIG. 1 is used to expand an existing Wi-Fi network. For example, if a particular business entity is constructing a new campus consisting of several buildings, it is not unusual for one building to be completed first and occupied while the remaining buildings are finished one after another. The process 100 of FIG. 1 may be used in connection with outfitting the first building with a Wi-Fi network. Thereafter, when a second building is complete enough to set up the Wi-Fi network in that building, the process 100 of FIG. 1 may be used to add Wi-Fi access points in the second building to the Wi-Fi network of the original or first building.

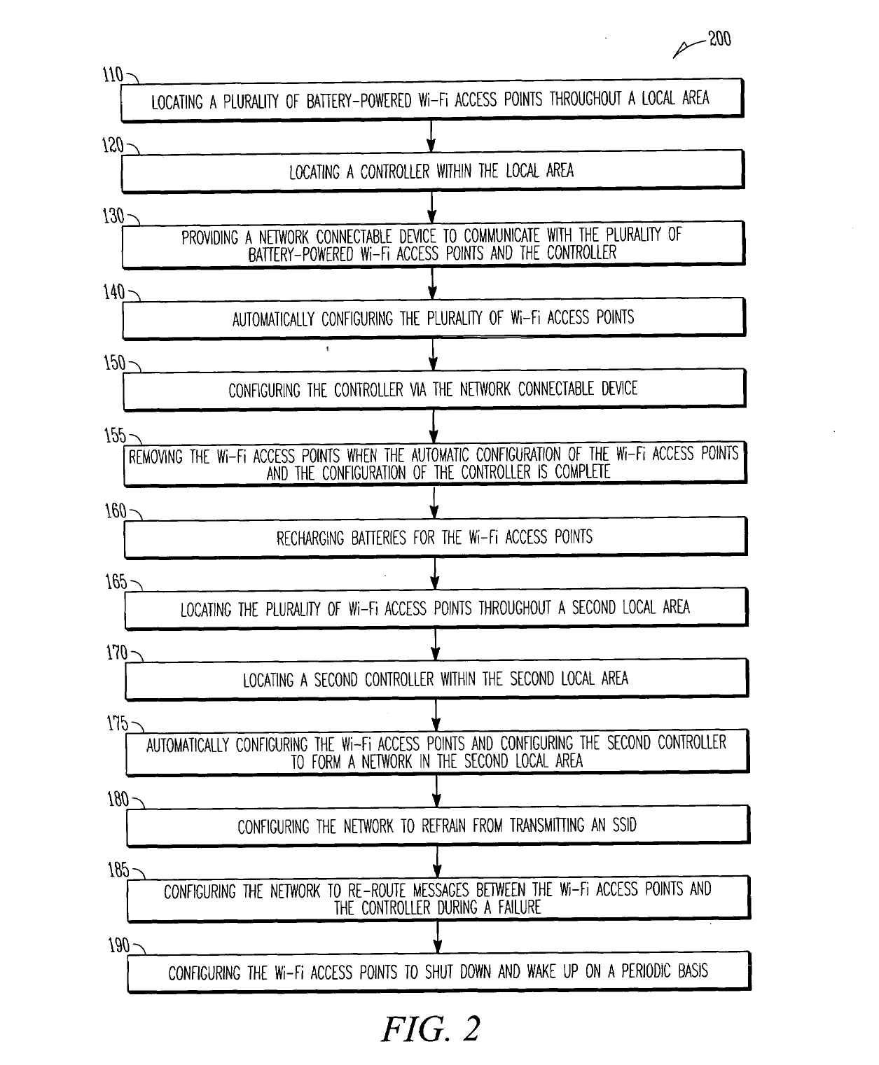

In an embodiment, the Wi-Fi access points include Wi-Fi routers, and in another embodiment, the Wi-Fi access points include Wi-Fi mesh routers. Referring to FIG. 2, another embodiment of a process 200 to install a network is illustrated. As can be seen in FIG. 2, the process steps 110, 120, 130, 140, and 150 of process 100 of FIG. 1 are also in the process 200 of FIG. 2. Additionally, in the embodiment of FIG. 2, the batteries used to power the Wi-Fi access points are rechargeable. At operation 155 in FIG. 2, the Wi-Fi access points are removed from a location when the automatic configuration of the Wi-Fi access points and the configuration of the central controller is complete. In operation 160, the batteries for the Wi-Fi access points are recharged, and in operation 165, the Wi-Fi access points are located in a second building or second area. At operation 170, a second controller is located within the second local area, and at operation 175, the Wi-Fi access points are automatically configured and the second controller is configured to form a network in the second local area. At operation 180, the network is configured so that it does not broadcast an SSID. In this manner, the Wi-Fi network is not visible to the outside world. At operation 185, the network is configured to re-route messages within the network when there is a failure in the network. At operation 190, the Wi-Fi access points are configured with a protocol such that the access points shut themselves down. This protocol further causes the access points to wake up on a periodic basis and reconnect to the network, and listen for a wakeup message from the controller.

As previously alluded to, in an embodiment, the Wi-Fi access points are self-configuring. Such a self configuring access point is capable of automatically forming a network with other Wi-Fi access points and/or a controller. One manner through which this may be accomplished is the use of mesh technologies and automatic addressing mechanisms. For example, a central controller may be set up and initially configured, and a first Wi-Fi access point may be added. Through the gateway connecting the access point and the controller, the controller knows all that it needs to know about the Wi-Fi access point, and the Wi-Fi access point knows all that it needs to know about the central controller. Then, as additional Wi-Fi access points are added to the network, the added access points know all about the central controller and existing access points through the gateway.

As disclosed in operation 180 in FIG. 2, in an embodiment, the network may be configured to refrain from broadcasting an SSID. As a result, the installed temporary network remains separate and hidden from any other Wi-Fi network that may be installed in the locality. The temporary network will then not be recognized by any other Wi-Fi network access point in the locality, and the temporary network will not interfere with any of those other access points or networks.

In an embodiment, a temporarily installed network uses the existing Wi-Fi protocol as is known in the art. However, to avoid the rapid depletion of the batteries by the rather intense power requirements of the protocol, the network devices, on the application level, will be instructed to shut themselves down to save power. The access points may also be programmed to wake up periodically, connect to the network, and listen for wakeup messages. If there are none, the access point will then go back to sleep again. Thereafter, when the controller broadcasts a wakeup message (or a wakeup message is broadcast via a laptop connected to the network), the access points will detect this wake up message, and then be up and operational for use.

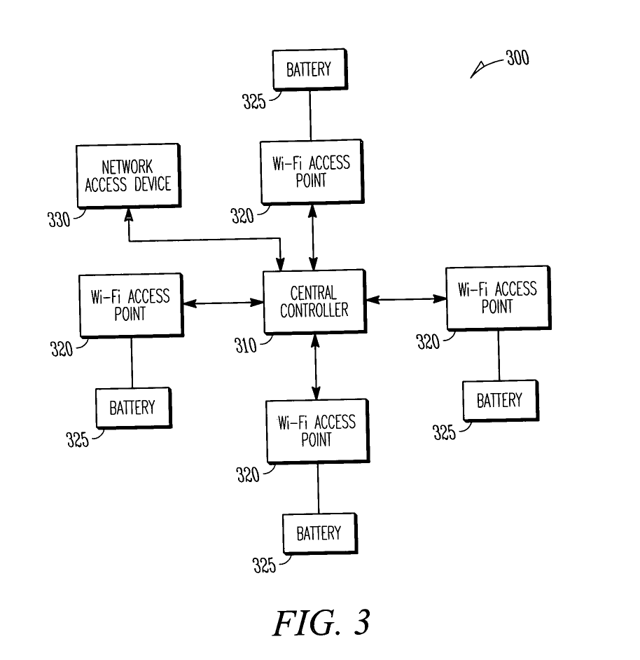

FIG. 3 illustrates an example embodiment of a Wi-Fi network installed in a building, structure, or other location. As previously disclosed, such a building may be a newly commissioned building in which all the resources needed for configuring a central controller and network access points are not available. FIG. 3 illustrates a block diagram of a temporary network 300. A central controller 310 is located in a building or other locality. Placed throughout the locality 300 are Wi-Fi network access points 320. In an embodiment, each network access point 320 has associated with it its own battery 325. In another embodiment, two or more access points may share the same battery. After the placement of the Wi-Fi access points 320, a user 330, through a laptop computer, electronic personal assistant, or other network connectable device, may access the temporary network and configure and/or reconfigure the access points (or initiate the automatic configuration of the access points) and/or the central controller. Once again, because the access points are powered by a battery, this configuration may be performed in a newly configured building before the building is completely powered. After the configuration of the central controller and access points is complete, the batteries associated with the Wi-Fi access points may be removed, and the batteries recharged for use in another configuration operation.

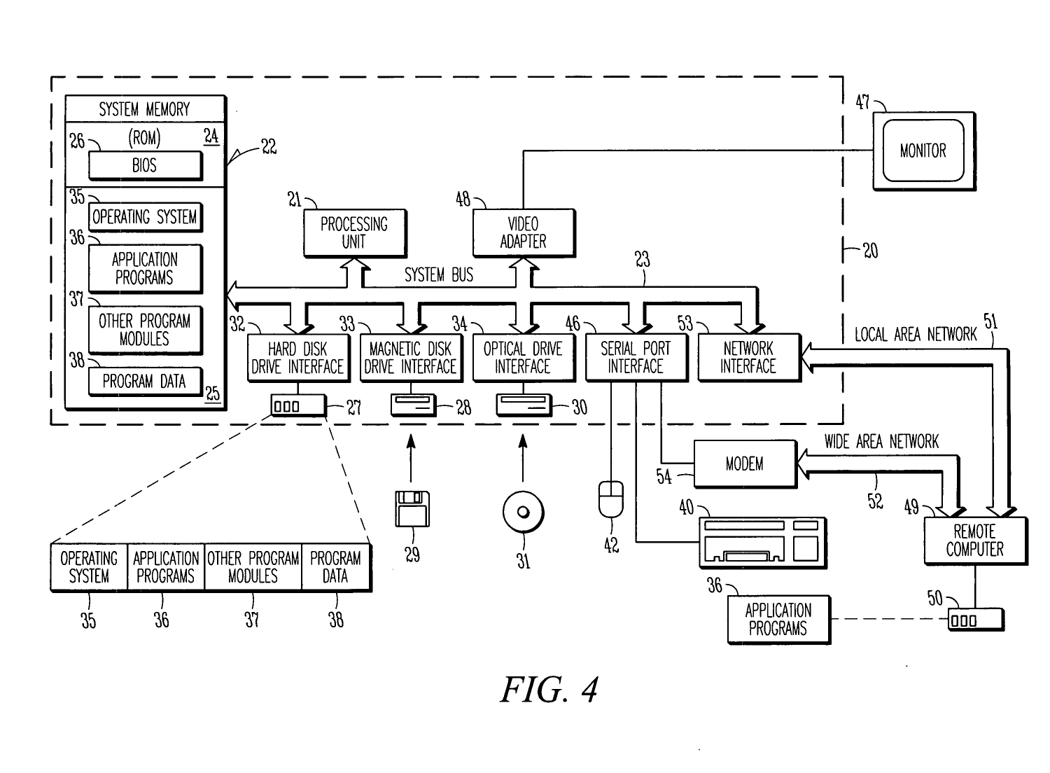

FIG. 4 is an overview diagram of a hardware and operating environment in conjunction with which embodiments of the invention may be practiced. The description of FIG. 4 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/0 remote processing devices that are linked through a communications network. In a distributed computing environment, program modules may be located in both local and remote memory storage devices.

In the embodiment shown in FIG. 4, a hardware and operating environment is provided that is applicable to any of the servers and/or remote clients shown in the other Figures.

As shown in FIG. 4, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 4 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A process comprising:
locating a plurality of battery-powered Wi-Fi access points throughout a local area;
locating a controller within said local area;
providing a network connectable device to communicate with said plurality of battery-powered Wi-Fi access points and said controller;
automatically configuring said plurality of Wi-Fi access points; and
configuring said controller via said network connectable device.

2. The process of claim 1, further comprising:
removing said plurality of battery-powered Wi-Fi access points when said configuring of said plurality of Wi-Fi access points and said controller is complete.

3. The process of claim 1, wherein said Wi-Fi access points comprise one or more Wi-Fi routers.

4. The process of claim 1, further comprising:
configuring said battery-powered Wi-Fi access points to be rechargeable;
locating a plurality of Wi-Fi access points throughout a second local area;
locating a second controller within said second local area;
automatically configuring said plurality of Wi-Fi access points located throughout said second local area; and
configuring said second controller with said network connectable device.

5. The process of claim 1, wherein said local area comprises a newly commissioned or a newly recommissioned building.

6. The process of claim 1, wherein said auto-configuration of said Wi-Fi access points and said configuration of said controller forms a network.

7. The process of claim 6, further comprising configuring said network to refrain from broadcasting an SSID.

8. The process of claim 6, wherein said Wi-Fi access points comprise a protocol wherein said Wi-Fi access points shut themselves down, and further wherein said protocol causes said Wi-Fi access points to wake up on a periodic basis and reconnect to said network and listen for a wakeup message from said controller.

9. The process of claim 6, wherein said network comprises a Wi-Fi mesh network.

10. The process of claim 6, further configuring said network to re-route messages between said plurality of Wi-Fi access points and said controller when a failure occurs in said network.

11. The process of claim 6, further comprising using mesh technology and automatic addressing mechanisms to configure said network of said plurality of Wi-Fi access points and said controller.

12. A system comprising:
a central controller;
one or more Wi-Fi access points forming a network with said central controller;
a network access device to access said network; and
a battery powered source connectable to said one or more Wi-Fi access points.

13. The system of claim 12, wherein said central controller is configurable via said network access device.

14. The system of claim 12, wherein said network is temporarily installed in a building.

15. The system of claim 12, wherein said one or more Wi-Fi access points are automatically configurable and said central controller is configurable via said network access device.

16. The system of claim 12, wherein said network comprises a Wi-Fi mesh network.

17. The system of claim 12, wherein said network is configured to refrain from broadcasting an SSID.

18. A network comprising:
a controller;
a plurality of Wi-Fi access points wirelessly coupled to said controller; and
a battery powered source to supply power to one or more of said plurality of said Wi-Fi access points;
wherein one or more of said Wi-Fi access points are temporarily placed in a structure.

19. The network of claim 18, wherein said structure is a newly commissioned or newly re-commissioned building.

20. The network of claim 18, further comprising a network access device to access said controller and said plurality of Wi-Fi access points.
